(19) United States
(12) Patent Application Publication
(10) Pub. No.: US 2016/0176222 A1
(43) Pub. Date: Jun. 23, 2016

(54) IMPROVEMENTS IN SECURITY ELEMENTS

(71) Applicants: James Peter SNELLING, Andover, Hampshire (GB); DE LA RUE INTERNATIONAL LIMITED, Basingstoke, Hampshire (GB)

(72) Inventor: James Peter SNELLING, Andover, Hampshire (GB)

(21) Appl. No.: 14/908,738

(22) PCT Filed: Jul. 17, 2014
(86) PCT No.: PCT/GB2014/052182

§ 371 Date: Jan. 29, 2016

(30) Foreign Application Priority Data
Jul. 29, 2013 (GB) 1313502.5

(51) Int. Cl. B42D 25/355; B42D 25/23; B42D 25/24; B42D 25/29

(52) U.S. Cl. CPC B42D 25/355; B42D 25/29; B42D 25/23; B42D 25/24

(57) ABSTRACT

The present invention relates to improvements in security elements for use in or on security substrates. The security element comprises a first light transmitting carrier substrate and at least two regions of material extending substantially parallel to each other along at least a part of the length of the security element. A transverse gap of at least 1 mm lies between the regions of material. The security element further comprises an infill layer which at least partially fills the transverse gap between the regions of material. The infill layer transmits light, such that a layer located on an opposing side of the infill layer from the viewing side is visible through the infill layer when the security element is viewed in transmitted light.

### TECHNICAL FIELD

The present invention relates to improvements in security elements for use in or on security substrates

### BACKGROUND

It is widely known to use security elements, such as security threads or strips, in security substrates used to manufacture banknotes, passports, certificates, and other security documents. The security elements comprise security features which enhance the anti-counterfeitability of the security substrate and any security document made therefrom. These security elements may be partially or wholly embedded in a paper or plastic substrate, or applied to the surface thereof, and generally provide different viewing conditions depending on whether the security document is viewed in transmitted or reflected light.

EP-A-319157, for example, describes a security element made from a transparent plastic film provided with a continuous reflective metal layer, such as aluminium, which has been vacuumed deposited on the film. The metal layer is partially demetallised to provide clear demetallised regions that form negative indicia. When wholly embedded within a paper substrate, the security element is barely visible in reflected light. However, when viewed in transmitted light the negative indicia can be clearly seen highlighted against the dark background of the metallised area of the security element and adjacent areas of the paper. Such elements can also be used in a security document provided with repeating windows in at least one surface of the paper substrate, in which the security element is exposed. A security document of this type, when viewed in transmitted light, will be seen as a dark line with the indicia highlighted. When viewed in reflected light on the windowed side, the bright shiny aluminium portions are readily visible in the windows. This security element has been highly successful within the market place and is supplied under the trade mark Cleartext® by De La Rue International Limited.

For a number of years, banknote issuing authorities have had an interest in increasing the security (anti-counterfeitability) of banknotes by incorporating security elements with covert properties provided by a machine-readable feature. The incorporation of a machine-readable feature into a security element facilitates an automatic authenticity check. It is preferable to utilise machine-readable features that can be read using detectors already available to the banknote issuing authorities. For example, machine readable magnetic regions on a security element can be detected and analysed by a magnetic sensor of a banknote processing system.

WO-A-92/11142 and WO-A-2007/036696 disclose security elements having a magnetic feature in the form of tramlines along the edges of the security element running parallel to its longitudinal axis. Such magnetic tramlines have the advantages that they do not obscure information provided on the security element and are cheaper to produce than using a magnetic material to form the partially demetallised layer.

There is an increasing trend towards the use of wider security elements in security paper, for example security elements having a width of 3 mm or more. This trend is due to the fact that wider security elements provide a larger surface area, which enables the provision of more detailed, and clearer, information thereon. A larger surface area also allows for better use of optically variable devices (OVDs). However, problems are encountered when providing magnetic tramlines on such wider security elements. The presence of the tramlines at the edges of the security element means that there is an increase in thickness at those locations when compared to the central region of the security element. This can cause such wider security elements to be susceptible to a phenomenon known as ‘tin canning’, wherein corrugations form in the security element between the tramlines, parallel to its longitudinal axis. This is a problem both in web based manufacturing of security threads and in the resultant paper. In web based manufacturing, the tin canning can lead to a loss of both cross- and machine-direction register control during manufacturing operations. This can result in mis-registered printing or slitting faults in the final thread product. In addition, the presence of tramlines will result in varying mechanical properties across the transverse direction of the thread, which may cause it to tend to fold over or crease; it is thought that the presence of a thread with a prevalence for folding over or creasing may lead to quality problems during papermaking and print operations. Tin canning and the other described problems are not only a problem with security elements which have magnetic tramlines, but for any security element which has longitudinal areas of increased thickness with thinner regions between.

### SUMMARY

The invention therefore provides an elongate security element having a length, comprising: a first light transmitting carrier substrate; at least two regions of material extending substantially parallel to each other along at least a part of the length of the security element and having a transverse gap of at least 1 mm between the regions of material; and an infill layer; wherein the infill layer at least partially fills the transverse gap between the regions of material; and the infill layer at least partially transmits light such that a layer located on an opposing side of the infill layer from the viewing side is visible through the infill layer when the security element is viewed in transmitted light.

The invention further provides an elongate security element having a length, comprising: a first light transmitting carrier substrate; at least two continuous regions of material extending substantially parallel to each other along substantially the whole length of the security element and having a transverse gap of at least 1 mm between the regions of material; and an infill layer; wherein the infill layer at least partially fills the transverse gap between the regions of material.

The invention further provides a security substrate comprising a base substrate and an aforementioned security element wholly or partially embedded in the substrate.

The invention further provides a security substrate comprising a base substrate and an aforementioned security element applied to the surface of the substrate.

The invention further provides a security document formed from an aforementioned security substrate comprising printing on at least one surface of the security substrate.

By providing an infill layer between the regions of material, the thickness of the security element in the central region between the regions of material is increased, which reduces the likelihood of tin canning.

### BRIEF DESCRIPTION OF THE DRAWINGS

A preferred embodiment of the present invention will now be described, by way of example only, with reference to the accompanying drawings, in which:

FIG. 1 is a plan view of a first embodiment of a security element according to the present invention;

FIG. 2 is a cross-sectional end elevation of the security element of FIG. 1 along the line I-I;

FIG. 3 is a plan view of a second embodiment of a security element according to the present invention;

FIG. 4 is a cross-sectional end elevation of the security element of FIG. 3 along the line II-II;

FIG. 5 is an alternative cross-sectional end elevation of the security element of FIG. 3 along the line II-II;

FIG. 6 is a plan view of a third embodiment of a security element according to the present invention;

FIG. 7 is a plan view of a fourth embodiment of a security element according to the present invention;

FIG. 8 is a plan view of a fifth embodiment of a security element according to the present invention; and

FIG. 9 is a plan view of a sixth embodiment of a security element according to the present invention.

### DETAILED DESCRIPTION

In the context of the present invention, an ‘opaque’ material is defined as one which permits substantially no light in the visible spectrum (having a wavelength from approximately 380 nm to approximately 780 nm) to pass through it. A ‘transparent’ material is defined as one which permits substantially all light in the visible spectrum to pass through it. A transparent material may be colourless or coloured. A ‘semi-transparent’ material is defined as one which permits some light in the visible spectrum to pass through it. For the purpose of this application, semi-transparent is preferably defined as having an optical density of 0.05-0.5. A suitable instrument for measuring optical density would be a Macbeth TD932 densitometer.

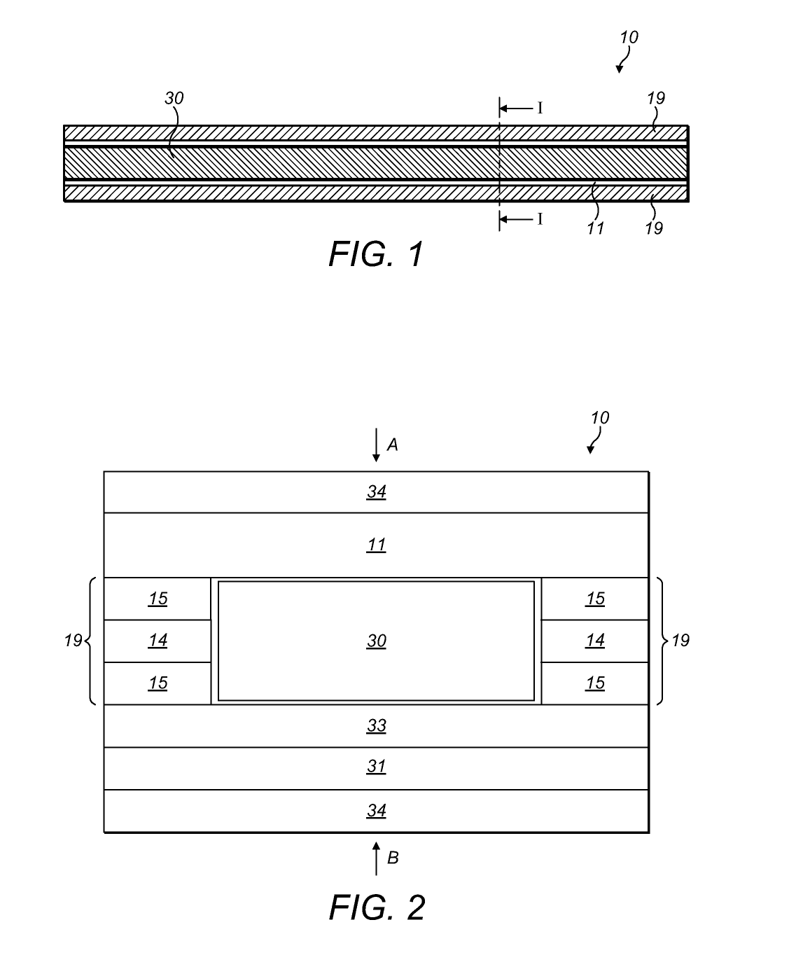

FIGS. 1 and 2 illustrate a first embodiment of a security element 10 according to the present invention. The security element 10 is elongate, in that it has a length that is greater than its width. The security element 10 comprises a first carrier substrate 11, preferably made from a water impermeable, light transmitting polymeric material. An example of a suitable polymeric material for the carrier substrate is Mylar® 813 from DuPont. The first carrier substrate 11 is preferably wider than 3 mm, and more preferably wider than 4 mm. Examples of suitable thicknesses for the first carrier substrate 11 are 6 μm, 12 μm, or 19 μm.

At least two elongate regions of material 19 are provided on the first carrier substrate 11. The at least two regions of material 19 extend substantially parallel to each other along at least a part of the length, and preferably along substantially the whole length of the security element 10, with a transverse gap of at least 1 mm between the regions of material 19. A suitable width for each region of material 19 may be 0.25-0.5 mm. However, it should be noted that wider security elements 10 would enable the use of wider regions of material 19. A suitable thickness (depth) of the regions of material 19 is 1-10 μm, more preferably 2-4 μm. The regions of material 19 may be continuous or may comprise breaks in the material or repeating blocks to form a code, as is well know in the art. The code may be a spatial code and/or may be generated by the use of materials with different properties such as magnetic coercivity. Where the regions of material 19 are not continuous, they preferably occupy at least 25% of the whole length of the security element 10. More preferably they occupy 50% of the whole length of the security element and even more preferably 100% of the whole length of the security element. Preferably the transverse gap is present for at least 50% of the length of the regions of material 19 and more preferably at least 75% and even more preferably it is present for the full length of the region of material 19. This applies to the case where the regions of materials 19 are continuous or not.

The regions of material 19 comprise a first layer 14 of any suitable material, which is generally used to provide a security feature. For example, the first layer 14 may be in the form of printed magnetic ink, fluorescent ink, conductive ink, or any other suitable material. In the case of a magnetic ink, suitable magnetic materials include iron oxide pigments (Fe₂O₃ or Fe₃O₄), barium or strontium ferrites, iron, nickel, cobalt, and alloys of these. In this context the term ‘alloy’ includes materials such as nickel:cobalt, iron:aluminium:nickel:cobalt, and the like. Further suitable magnetic materials include flake nickel materials and iron flake materials. Typical nickel flakes have lateral dimensions in the range of 5-50 μm and a thickness of less than 2 μm. Typical iron flakes have lateral dimensions in the range 10-30 μm and a thickness less than 2 μm.

Optionally, the regions of material 19 may be formed from two or more superposed layers of material. In this embodiment a second layer 15 is arranged to overlie and cover both sides of the first layer 14. The second layer 15 may be a concealing layer. The concealing layer may be of any colour which is desirable to be seen. A suitable material for the concealing layer is Luminescence 61466G Silver SB Gravure ink. The second layer 15 is preferably at least as wide as the first layer 14; in practice, the second layer 15 may be marginally wider than the first layer 14 due to manufacturing tolerances. Alternatively, another material may be used for the second layer 15 to provide a desired effect or function.

An infill layer 30 is provided on the first carrier substrate 11 in the gap between the regions of material 19. The infill layer 30 is preferably not present on other areas of the first carrier substrate 11 outside the gap between the regions of the material 19. The infill layer 30 at least partially fills the gap between the regions of material 19, both in the transverse direction and depth direction. The infill layer 30 may wholly fill the gap between the strips 19 in the transverse direction. Alternatively, a transverse gap may be present between one or each region of material 19 and an edge of the infill layer 30. Preferably, the transverse gap is less than or equal to 1 mm. The minimum width of the infill layer 30 is thus determined by the transverse gap between the regions of material 19 resulting from the formation of the security feature on the security element 10. Hence, for a security element 10 on which there is a transverse gap of 2.5 mm between the regions of material 19, the minimum width of the infill layer 30 would be 0.5 mm, leaving the maximum preferred transverse gap of 1 mm between each edge of the infill layer 30 and an adjacent region of material 19.

The infill layer 30 may comprise a plurality of longitudinal elements having transverse gaps between them, wherein the maximum width of each transverse gap is 1 mm. Preferably, the infill layer 30 has a depth of at least 50% of the depth of the regions of material 19. If the infill layer 30 is substantially as deep as the regions of material 19, a substantially planar surface will be formed by the regions of material 19 and the infill layer 30, which is advantageous.

The infill layer 30 may be in the form of an ink or a varnish, and may be printed or coated onto the first carrier substrate 11. Preferably, the infill layer 30 is transparent or semi-transparent. Preferably, the infill layer 30 has an optical density of less than or equal to 0.5. Optical density can be measured on a Macbeth TD932 densitometer. However, the infill layer 30 may also be opaque. Examples of suitable materials include acrylic or vinyl resins. An example of a suitable semi-transparent material is Sun Chemical YSIL-01-21879, which may typically have an optical density of 0.1-0.3, although other suitable products may have an optical density of 0.05-0.5. An example of a suitable transparent material is Sun Chemical YSIL-70-21878. The infill layer 30 may be coloured by the use of a dye or pigment. The infill layer 30 may have light scattering properties or may be non-light scattering.

Optionally, the infill layer 30 may also comprise a security feature for authentication purposes, such as luminescent properties. Luminescent materials are well known to the skilled person, and include materials having fluorescent or phosphorescent properties. The use of luminescent features on security elements is described in EP-A-303725, EP-A-319157, and WO-A-2006051231. The luminescent colour may be the same as, or different from, luminescent colour(s) which may be provided on other layers within the security element 10. The luminescent infill layer 30 may be rainbowed in the longitudinal direction of the security element 10 to produce a multicoloured effect. Rainbowing of a luminescent print feature in the longitudinal direction of a security element is described in EP-A-303725. The infill layer 30 may additionally or alternatively comprise other materials that respond visibly to some form of non-visible radiation, such as infrared responsive, photochromic, and thermochromic materials. Such materials are known to the skilled person. A further optional security feature is for the infill layer 30 to comprise a transparent magnetic material, such as are now available from a number of suppliers. Examples of such materials are described in U.S. Pat. No. 6,296,996, EP-A-660311, U.S. Pat. No. 5,520,954, EP-A-994386, and U.S. Pat. No. 6,258,519, and references therein.

Optionally, the security element 10 may further comprise a second carrier substrate 31, which may be of a similar material to the first carrier substrate 11. The second carrier substrate 31 may be added to increase the durability of the security element 10. A suitable laminating adhesive 33 is applied to one side of the second carrier substrate 31. An example of a suitable laminating adhesive 33 is Novacote® 10-2525/3346. The thickness of the laminating adhesive 33 may be 1-3 μm. The second carrier substrate 31 is laminated to the region of material 19 side of the first carrier substrate 11, to form the security element 10.

Optionally, one or more water based adhesive layers 34 may be applied to each side of the security element 10 to aid its adhesion when embedded in a security substrate (not shown). An example of a suitable adhesive is National Starch & Chemical Eclipse 033-4172.

In the above-described embodiment, the infill layer 30 is provided as an internal layer within the structure of the security element 10, between the regions of material 19. Alternatively, the infill layer 30 may be provided as an external layer (not shown) on the security element 10. The external infill layer (not shown) would have the same properties and dimensions as the internal infill layer 30, the only difference being its location on the outside of the security element 10. However, an advantage of the internal infill layer 30 is that it may be protected from external attack, both in terms of general durability and specific solvent or water-based hazards. This may be particularly important if the infill layer 30 comprises an additional authentication feature such as luminescent material. Additionally, an internal infill layer 30 may improve the lamination of the security element 10 in the region of the transverse gap between the regions of material 19, as there will be a more planar surface with the laminating adhesive 33.

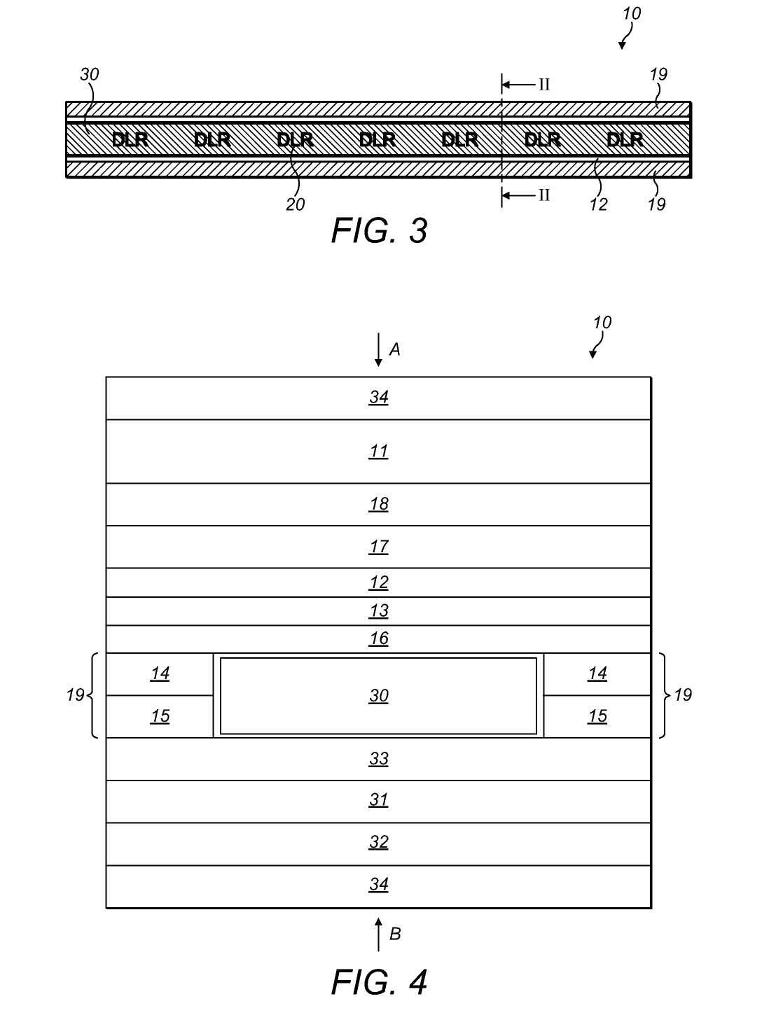

FIGS. 3 and 4 illustrate a second embodiment of a security element 10 according to the present invention. The second embodiment of the security element 10 is similar to the first embodiment with respect to their common layers, but the second embodiment further comprises a number of additional layers.

In the second embodiment of the security element 10, indicia 20 are preferably provided in an indicia layer 12 on the first carrier substrate 11, in the form of words, numerals, patterns, pictures, and the like. The indicia 20 are defined by a plurality of opaque regions and clear regions (i.e. where no opaque material is present). When viewed in transmission, light is visible in the clear regions, thereby highlighting the indicia 20. The indicia 20 may be positive, with the opaque regions forming the indicia 20. Alternatively, the indicia 20 may be negative with the clear regions forming the indicia 20. This may be achieved using a metallisation or demetallisation process, or using opaque or metallic inks. Whilst it is preferred that the clear regions are metal or opaque material free, it is possible to leave a very thin layer of metal or opaque material which transmits sufficient light such that the indicia 20 are still visible in transmitted light.

In one embodiment, the indicia layer 12 is formed by depositing a thin opaque metal layer on one side of the first carrier substrate 11. The metal is preferably aluminium, or it may be another suitable material. A typical metal layer as commonly used in the art has an optical density of 2.5±0.5. Parts of the metal layer are then removed to form the indicia layer 12. In the embodiment shown, the metal layer is printed with a resist 13 to form the indicia 20. The resist 13 may be colourless or may be coloured with a dye or pigment, depending on the desired effect. A suitable resist coat weight is in the region of 1 gsm. An example of a class of suitable resist materials is vinyl chlorides/vinyl acetate copolymers such as Union Carbide Ucar resins, Sun Chemical YSIL-70-21878, or Wacker Vinnol E 15/45m. The printed metallised first carrier substrate 11 is then partially demetallised according to a known demetallisation process, using a caustic wash which removes the metal in the regions not printed with the resist 13. This process leaves metal free, or substantially metal free, clear regions (see FIGS. 2 to 5) in the metal layer with the remaining metal still covered by the resist 13. The resist 13 may be printed so as to form positive or negative indicia 20 (see FIGS. 2 to 5), in which case the resulting indicia 20 will be provided by the demetallised regions.

As an alternative to such a resist and etch process, the metal layer may be partially removed by another demetallisation process to leave the metal free, or substantially metal free, areas, for example direct etching by means of a laser or the like. Such alternative demetallisation processes would not require the resist 13. Further alternatively, the demetallisation process can take place by applying a masking substance onto the first carrier substrate 11 which either inhibits adhesion of the vapour deposited metallic layer to the carrier substrate 11 and/or obstructs deposition of the vapour deposited metallic layer onto the substrate in the first place. In one example, the masking substance may comprise a soluble mask, such as a soluble ink (comprised of an appropriate binder and pigment combination). The soluble mask may not adhere strongly to the carrier substrate 11, or may be dissolved by application of a solvent (aqueous or otherwise), thereby impeding adhesion of the reflection enhancing material (i.e. the metal layer) applied to the carrier substrate 11 over the soluble mask. In this case a washing step may be required. Examples of a suitable soluble mask in the form of a heavily pigmented ink are described in WO-A-9913157.

The indicia layer 12 may also be provided by printing the first carrier substrate 11 with conductive or non-conductive metal-effect or other opaque inks.

The regions of material 19 are preferably applied after the indicia layer 12 has been formed, such that the remaining layer of resist 13 lies between the regions of material 19 and the indicia layer 12.

The infill layer 30 may be arranged so that it at least partially overlies the indicia layer 12, overlapping at least some of the clear regions forming the indicia 20. Alternatively, it may be arranged to fully cover the indicia layer 12 within the transverse gap between the regions of material 19. The infill layer 30 is therefore preferably sufficiently transparent or semi-transparent such that the presence of positive or negative indicia 20 in the indicia layer 12 can be observed through the infill layer 30 when viewed in transmitted light.

Optionally, a protective layer 16 may be provided between the indicia layer 12 and the regions of material 19. The protective layer 16 may be an anti corrosion protection lacquer. An example of a class of suitable materials is vinyl chlorides/vinyl acetate copolymers such as Sun Chemical YSIL-70-21878, or a water based cross-linked acrylic. When a resist 13 is present, the protective layer 16 may have the same dimensions as the resist 13. If no resist 13 is present, the protective layer 16 may be an all over coating on the security element 10. The protective layer 16 may prevent the metal layer or other opaque layer, from being chemically attacked or corroded.

Optionally, a colourshifting effect may be produced by providing a suitable colourshift device. In FIG. 4 this is provided by a dielectric layer 17 and an absorber layer 18 arranged between the first carrier substrate 11 and the indicia layer 12, which in this case is metallic. This produces a superposition of the absorber layer 18, the dielectric layer 17, and the reflective metal indicia layer 12. It is well known in the art that such a combination produces a colourshift effect. Such devices are commonly referred to as thin film optical multilayer devices (see, for example, ‘Optical Document Security’, chapter 13, 2^{nd} Edition, Edited by R. L. Van Renesee). The colourshift effect will only be visible when the direction of view (see arrow A) is such that the absorber layer 18 overlies the dielectric layer 17, as it is the absorber layer's 18 semi-transparency which gives the observed colour.

In an alternative embodiment, the absorber layer 18, dielectric layer 17 and the reflecting indicia layer 12 may be external to the security element 10, i.e. they may be located on top of the first carrier substrate 11.

Optionally, a masking coat 32 may be provided on one side of the second carrier substrate 31. Masking coats are customarily used on security elements having a width greater than approximately 2 mm to hide surfacing of the security element on the embedded paper side. A suitable material for such a masking coat 32 would be Sun Chemical YSIL-01-21879. A typical coat weight is suggested to be in the region of 2 gsm. Such a masking coat 32 has similar scattering properties to paper, such that light reflected from the security element 10 appears diffuse and has a paper-like appearance. The masking coat 32 may also include fluorescent pigments.

A single substrate variant of the embodiment of FIGS. 3 and 4 would be possible, having only the first carrier substrate 11. Such an embodiment would omit the second carrier substrate 31 and the laminating adhesive 33.

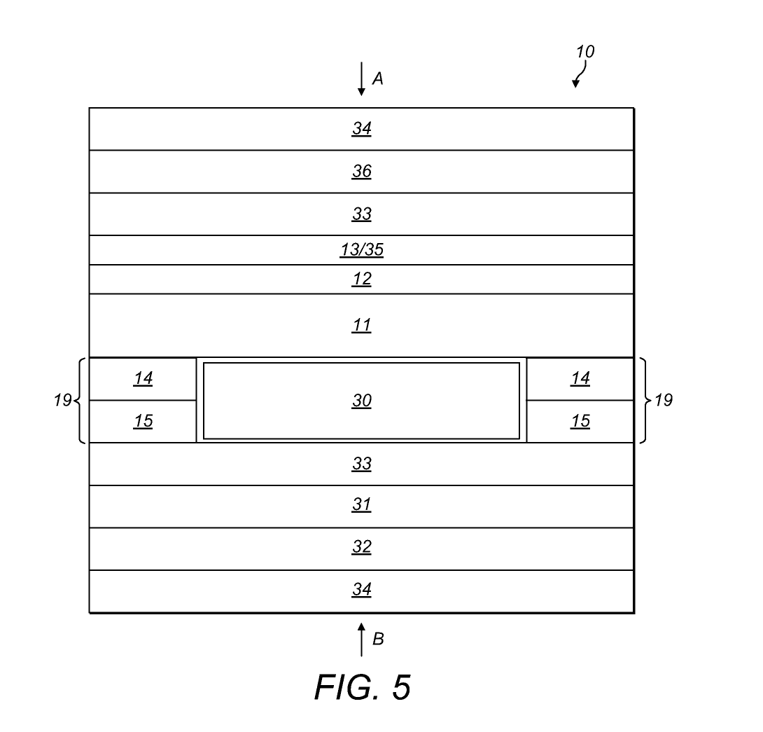

FIG. 5 illustrates an alternative variant of the second embodiment of a security element 10 according to the present invention. This variant is similar to the previously described second embodiment with respect to their common layers, but the optional colourshifting effect is produced using a cholesteric liquid crystal layer 36 instead of a dielectric layer 17 and an absorber layer 18.

In order to do this, the indicia layer 12 is formed on the first carrier substrate 11, as described above. A dark absorbing layer 35, which may be in the form of a dark or black resist 13, is applied to the indicia layer 12. When a dark resist 13 is used as the dark absorbing layer 35, it is the same resist which is used in the etching of the metal of the indicia layer 12. Suitable black or dark dyes or pigments for the resist 13 include the dye BASF Neozapon X51 or the pigment MCarbon Black 7″ (well dispersed) mixed into a material with both good adhesion to metal and caustic resistance. The dye loading can be up to 50% (by weight) of the final coat of resist depending on coat thickness and desired blackness. An example of a class of suitable resist materials is vinyl chlorides/vinyl acetate copolymers such as Union Carbide Ucar resins, Sun VHL 31534, or Wacker Vinnol E 15/45m.

The liquid crystal layer 36 is applied to the dark resist 13 or other dark absorbing layer 35 using a laminating adhesive 33. In a preferred embodiment a polymer liquid crystal is used, but an alternate embodiment makes use of liquid crystal inks such as those supplied by Sicpa under the brand name Oasis®. An example of a suitable laminating adhesive 33 is Novacote® 10-2525/3346. The dark resist 13 or other dark absorbing layer 35 acts as a background to the liquid crystal layer 36 to provide a strong colourshifting effect with varying angle of viewing.

FIGS. 1, 3, and 6 to 9 illustrate various embodiments of security elements 10 according to the present invention, which demonstrate possible variations of the form of the infill layer 30. In each of these embodiments the infill layer 30 has the previously described properties, including any combination of the described optional properties. Additionally, it should be noted that the form of the regions of material 19 is not important to the invention. For example rather than the regions of material 19 having a linear form, as shown in FIGS. 1, 3, and 6 to 9, the regions of material 19 may have an oscillating form. They may also be continuous or non-continuous. They may also comprise indicia. They may also comprise layers of more than one material lying congruent to each other. The regions of material 19 in FIGS. 1, 3, and 6 to 9 merely signify the presence of a thickness which is not present in the region between the regions of material 19.

In the first embodiment, as illustrated in FIG. 1, no indicia are visible on the security element 10. The infill layer 30 is a simple linear structure. The infill layer 30 may be made of an opaque, semi-transparent, or transparent material. The infill layer 30 may be formulated such that it does not alter the appearance of the security element 10 in reflected light. For example, the infill layer 30 may have no apparent colour and may have minimal scattering properties. Alternatively, if it is desired for the infill layer 30 to be visible in reflected light, the infill layer 30 may comprise a component to provide reflective properties, such as a pigment, dye, or scattering agent.

In FIGS. 3 and 6 to 9, the infill layer 30 is shown in combination with the presence of negative indicia 20, which may be produced by the previously described methods. However, each of these embodiments may be varied to have positive indicia instead of, or in addition to, the negative indicia 20.

In the second embodiment, as illustrated in FIG. 3, the infill layer 30 is again a simple linear structure. In this case, the infill layer 30 is preferably made of an at least semi-transparent material, so that the negative indicia 20 are viewable through the infill layer 30 in transmitted light.

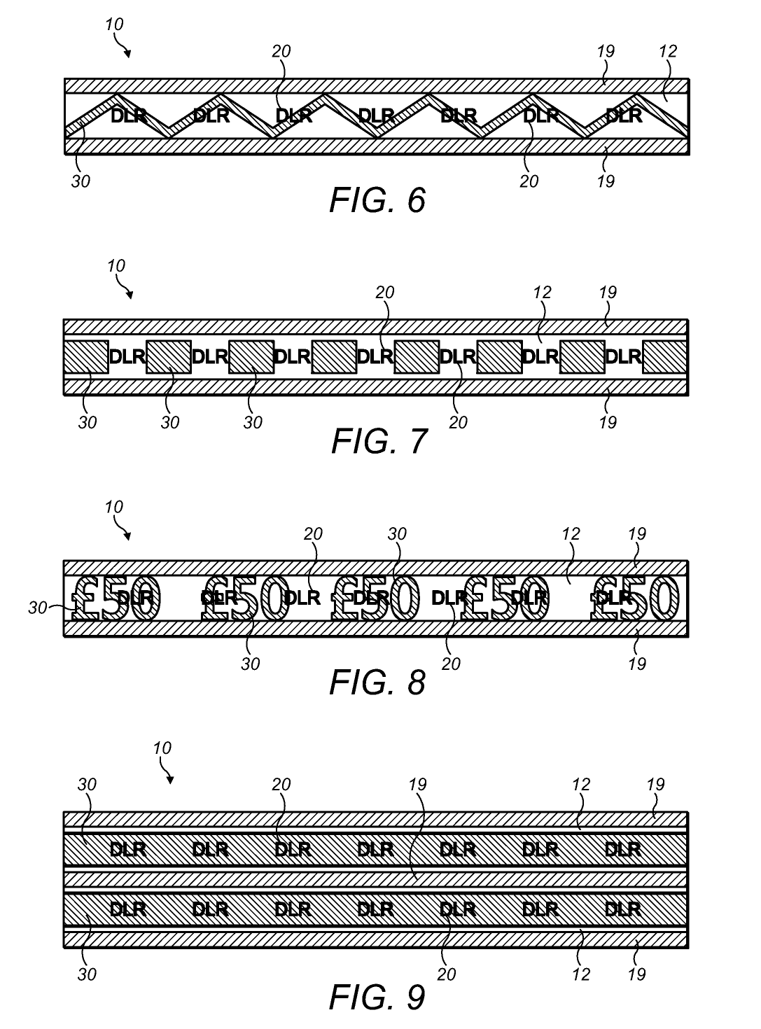

In the third embodiment, as illustrated in FIG. 6, the infill layer 30 is a zig-zag line running parallel to the longitudinal axis of the security element 10. In an alternative embodiment, the infill layer 30 may be in the form of another patterned line, such as another form of oscillating line, or the patterned lines described in WO-A-98/44199 which include scroll patterns.

In the fourth embodiment, as illustrated in FIG. 7, the infill layer 30 is registered to the negative indicia 20 such that the infill layer 30 and the negative indicia 20 do not overlap. In this case the infill layer 30 may be opaque.

In the fifth embodiment, as illustrated in FIG. 8, the infill layer 30 is in the form of indicia. The indicia may provide an additional authenticating element, which provides information. This information may be denomination information, or could be a name, signature, logo, picture, numerals, etc. The infill layer 30 may comprise a security feature to enable the identification of the indicia, such as a luminescent component which may fluoresce under UV light (as described above), and/or a magnetic component for machine readable application.

In the sixth embodiment, as illustrated in FIG. 9, the security element 10 has three regions of material 19, having a transverse gap of at least 1 mm between each adjacent pair of regions of material 19. The infill layer 30 as shown in FIG. 9 has the same form as that shown in FIG. 3, but any of the previously described variants of the infill layer 30 could be applied to a security element 10 having three regions of material 19. In further embodiments, any number of regions of material 19 may be present, with a transverse gap of at least 1 mm between each adjacent pair of regions of material 19, and again any variant of infill layer 30 may be used with these embodiments.

The security element 10 can be partially or wholly embedded into a base substrate (not shown), such as paper to form a security substrate which is used to manufacture secure documents. The embedment may be effected using any one of the methods known in the prior art. A wholly embedded security element 10 is covered on both sides by the substrate, whereas a partially embedded security element 10 is visible only partly on the surface of the document in the form of a windowed security element 10. In the latter construction, the security element 10 appears to weave in and out of the substrate and is visible in windows in one or both surfaces of the document. One method for producing paper with so-called windowed threads can be found in EP-A-0059056. EP-A-0860298 and WO-A-03095188 describe different approaches for the embedding of wider partially exposed security elements 10 into a paper substrate. The security element 10 may be incorporated into the base substrate such that regions of the device are visible on both sides of the substrate. Methods of incorporating a security device such that it is viewable from both sides of the substrate are described in EP-A-1141480 and WO-A-03054297. In the method described in EP-A-1141480, one side of the device is wholly exposed at one surface of the substrate in which it is partially embedded, and partially exposed in windows at the other surface of the substrate. Security elements 10 are now present in many of the world's currencies as well as vouchers, passports, travellers' cheques, and other documents.

1-44. (canceled)

45. An elongate security element having a length, the elongate security element comprising:
a first light transmitting carrier substrate;
at least two regions of material disposed on the first light transmitting carrier substrate and extending substantially parallel to each other along at least a part of the length of the security element and having a transverse gap of at least 1 mm between the at least two regions of material;
an infill layer; and
a further layer located on one side of the infill layer,
wherein the infill layer at least partially fills the transverse gap between the at least two regions of material, and
wherein the infill layer at least partially transmits light such that the further layer is visible through the infill layer when the security element is viewed in transmitted light.

46. The elongate security element as claimed in claim 45, wherein the at least two regions of material are continuous.

47. The elongate security element as claimed in claim 45, wherein the at least two regions of material extend along substantially the whole length of the security element.

48. The elongate security element as claimed in claim 45, wherein the infill layer has an optical density of less than or equal to 0.5.

49. The elongate security element as claimed in claim 45, further comprising:
at least one further region of material extending substantially parallel to the at least two regions of material along the length of the security element, and wherein there is a transverse gap of at least 1 mm between an adjacent pair of the at least one further region of material and/or the at least two regions of material, and an infill layer that at least partially fills the transverse gap between the adjacent pair of the further region of material and/or the at least two regions of material.

50. The elongate security element as claimed in claim 45, wherein the at least two regions of material comprise layers of more than one material superposed one above another.

51. The elongate security element as claimed in claim 45, wherein the at least two regions of material comprise layers of more than one material lying congruent to each other.

52. The elongate security element as claimed in claim 45, wherein the infill layer has light scattering properties.

53. The elongate security element as claimed in claim 45, wherein the infill layer comprises a security feature.

54. The elongate security element as claimed in claim 45, wherein the infill layer has a depth that is at least 50% of a depth of the at least two regions of material.

55. The elongate security element as claimed in claim 45, wherein the infill layer has a depth that is substantially the same as a depth of the at least two regions of material.

56. The elongate security element as claimed in claim 45, further comprising an indicia layer having a plurality of opaque regions and clear regions defining indicia which are visible in transmitted light.

57. The elongate security element as claimed in claim 56, wherein the infill layer at least partially overlaps the indicia of the indicia layer.

58. The elongate security element as claimed in claim 56, wherein the infill layer at least partially transmits light such that the indicia layer is visible through the infill layer when the security element is viewed in transmitted light.

59. The elongate security element as claimed in claim 56, wherein the infill layer does not overlap the indicia of the indicia layer.

60. The elongate security element as claimed in claim 45, further comprising: a gap between one or more of the at least two regions of material and the infill layer.

61. The elongate security element as claimed in claim 60, wherein the gap has a maximum width of 1 mm.

62. The elongate security element as claimed in claim 45, wherein the infill layer comprises a plurality of longitudinal elements running in a longitudinal direction of the security element, and wherein the longitudinal elements are separated from each other by a second transverse gap.

63. The elongate security element as claimed in claim 62, wherein the second transverse gap between the longitudinal elements has a maximum width of 1 mm.

64. The elongate security element as claimed in claim 45, wherein the infill layer is in the form of indicia.

65. A security substrate comprising:
a base substrate; and
the security element as claimed in claim 45, wherein the security element is wholly or partially embedded in the base substrate.

66. A security document formed from the security substrate of claim 65, further comprising at least one selected from the group consisting of: a banknote, an identity document, a passport, an identification card, a cheque, a visa, a certificate, and a stamp.

67. A security substrate comprising:
a base substrate, and
the security element as claimed in claim 45, wherein the security element is applied to a surface of the base substrate.

68. An elongate security element having a length, comprising:
a first light transmitting carrier substrate;
at least two continuous regions of material disposed on the first light transmitting carrier substrate and extending substantially parallel to each other along substantially the whole length of the security element and having a transverse gap of at least 1 mm between the at least two continuous regions of material; and
an infill layer, wherein the infill layer at least partially fills the transverse gap between the at least two continuous regions of material.

69. The elongate security element as claimed in claim 68, wherein the infill layer at least partially transmits light such that a layer located on an opposing side of the infill layer from a viewing side is visible through the infill layer when the security element is viewed in transmitted light.

70. The elongate security element as claimed in claim 68, wherein the infill layer has an optical density of less than or equal to 0.5.

71. The elongate security element as claimed in claim 68, further comprising:
at least one further continuous region of material extending substantially parallel to the at least two continuous regions of material along the length of the security element, and wherein there is a transverse gap of at least 1 mm between an adjacent pair of the at least one further continuous region of material and/or the at least two continuous regions of material, and an infill layer that at least partially fills the transverse gap between the adjacent pair of the at least one further continuous region of material and/or the at least two continuous regions of material.

72. The elongate security element as claimed in claim 68, wherein the at least two continuous regions of material comprise layers of more than one material superposed one above another.

73. The elongate security element as claimed in claim 68, wherein the at least two continuous regions of material comprise layers of more than one material lying congruent to each other.

74. The elongate security element as claimed in claim 68, further comprising: an indicia layer having a plurality of opaque regions and clear regions defining indicia which are visible in transmitted light.

75. The elongate security element as claimed in claim 74, wherein the infill layer at least partially overlaps the indicia of the indicia layer.

76. The elongate security element as claimed in claim 74, wherein the infill layer at least partially transmits light such that the indicia layer is visible through the infill layer when the security element is viewed in transmitted light.

77. The elongate security element as claimed in claim 74, wherein the infill layer does not overlap the indicia of the indicia layer.

78. The elongate security element as claimed in claim 77, wherein the infill layer is opaque.

79. The elongate security element as claimed in claim 68, wherein the infill layer has light scattering properties.

80. The elongate security element as claimed in claim 68, wherein the infill layer comprises a security feature.

81. The elongate security element as claimed in claim 68, wherein the infill layer has a depth that is at least 50% of a depth of the regions of material.

82. The elongate security element as claimed in claim 68, wherein the infill layer has a depth that is substantially the same as a depth of the at least two continuous regions of material.

83. The elongate security element as claimed in claim 68, further comprising a gap between one or more of the at least two continuous regions of material and the infill layer.

84. The elongate security element as claimed in claim 83, wherein the gap between the one or more of the at least two continuous regions of material and the infill layer has a maximum width of 1 mm.

85. The elongate security element as claimed in claim 68, wherein infill layer comprises a plurality of longitudinal elements running in longitudinal direction of the security element, the longitudinal elements being separated from each other by the transverse gap.

86. The elongate security element as claimed in claim 68, wherein the transverse gap is between an adjacent pair of the longitudinal elements and has a maximum width of 1 mm.

87. The elongate security element as claimed in claim 68, wherein the infill layer is in the form of indicia.

88. A security substrate comprising:
a base substrate; and
the security element as claimed in claim 68, wherein the security element is wholly or partially embedded in the base substrate.

89. A security document formed from the security substrate as claimed in claim 78, further comprising at least one selected from the group consisting of: a banknote, an identity document, a passport, an identification card, a cheque, a visa, a certificate, and a stamp.

90. A security substrate comprising:
a base substrate; and
the security element as claimed in claim 68, wherein the security element is applied to a surface of the base substrate.
